(19) United States
(12) Patent Application Publication
(10) Pub. No.: US 2004/0177017 A1
(43) Pub. Date: Sep. 9, 2004

(54) Distributed system and brokering method using context

(75) Inventors: Hidenori Yamamoto, Kawasaki (JP); Shigetoshi Sameshima, Machida (JP); Katsumi Kawano, kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/731,928

(22) Filed: Dec. 9, 2003

(30) Foreign Application Priority Data
Dec. 9, 2002 (JP) 2002-356128

(51) Int. Cl. G06F 17/60

(52) U.S. Cl. 705/35

(57) ABSTRACT

A distributed system in which a plurality of devices are coupled to each other through a network, includes a service scenario which describes functions necessary to provide a service and relations between the functions in general description; a context which serves as a criterion for selecting devices to be used in providing the service; an extraction unit which extracts devices necessary for the service based on the service scenario; a detection unit which detects devices located in a site where the service can be provided to a service requester; and a service execution unit which executes the service for the service requester by linking the devices detected based on the context.

### CROSS-REFERENCE TO RELATED APPLICATIONS

The present application claims priority upon Japanese Patent Application No. 2002-356128 filed on Dec. 9, 2002, which is herein incorporated by reference.

### BACKGROUND OF THE INVENTION

1. Field of the Invention

The present invention provides a service using a distributed system in which a plurality of devices are coupled to each other via a network. The present invention particularly relates to a technology dynamically performing functions and combinations thereof which are necessary to provide the service depending on the situation.

2. Description of the Related Art

It has been known that services are provided in the following manner (see “Dynamically Adaptive Networking Service Environment DANCE,” IEICE transactions, Vol. J82-B No. 5, pp. 730-739., for example). Among devices, software, contents, and the like which are coupled to a network, those located within a certain distance from a user are grouped. Subject to a request and a situation of the user, functions necessary for a service, specific information and coupling manners of network resources, and the like, necessary devices, software and the like are extracted from the group and linked to each other according to a service template. Herein, all information concerning the devices, software and the like are collected in a center database, and it is all managed by the center how to link the devices to construct the service.

In “The Design of Service Synthesizer on the Net,” IEICE Technical Report, IN2001-192, March 2001, a naming system is provided, which defines names of devices, software and the like which are coupled to a network with contents names, interface names and status names and manages the same. In this example, a service is provided by inquiring the naming system based on a service graph to find functions necessary for the service and by linking these functions to each other. The service graph describes a configuration of the functions for the service.

In the aforementioned conventional art, linkages between functions necessary for a service and a way of relating the functions are described in a scenario. However, the way of relating devices and software having the functions varies depending on conditions of the devices and a situation of a site where the service is actually provided using the devices. In some sites, there is a device having a plurality of functions, or in some sites, a plurality of devices have the same functions. Therefore, there are a plurality of ways of linking the devices having the functions described in the service scenario, and in some cases, a device configuration which is not suitable for the user's situation may be selected.

Moreover, frequencies of referring to context information, required information, conditions for linking devices, and the like vary by service. If conditions for the above items and the like are described within each application constituting a service, the burden on development is increased, and the expandability is reduced.

Furthermore, in the aforementioned conventional art, as for the device having a plurality of functions, when a plurality of users receive respective services in the same site, it is difficult to separately adopt the function for each user. Moreover, it is difficult to separately manage the operation of each function in each device.

### SUMMARY OF THE INVENTION

An object of the present invention is to provide a service based on a service scenario in general description by dynamically linking devices necessary to execute a service according to situations of users, conditions of devices, and the like without limiting a site.

In order to achieve the object, in providing a service based on a service scenario, the present invention searches for devices and software having functions described in the service scenario, and creates a local correspondence table between devices to be used for each of the devices which have detected based on information held by the devices, a server, and the like.

Herein, devices having the respective functions described in the service scenario are selected based on contexts, which are pieces of information, such as a situation of a user, a situation in an environment, and the like.

In creating the table, there are two methods of making correspondence between devices. In one method, devices and software having functions necessary to provide a service are selected by inquiring a device database stored in a server or the like and made correspondence with each other. In the other method, while searching first the periphery of a user for devices having functions equivalent to the functions described in a service scenario, devices having the functions that are related to each other in the service scenario exchange information, thereby making correspondence with each other.

When the contexts change, the devices having functions necessary for the service are redetected and linkage relations of the devices are reconstructed according to the contexts having changed to continue the service for the user.

Furthermore, in providing a service, relations between processes of executing the service as well as those between devices necessary to execute the service and a user receiving the service are combined to be managed.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a view showing a configuration of a system to which a service using device controls according to an embodiment of the present invention is applied;

FIG. 2 is a view illustrating a concept of a service scenario;

FIG. 3 is a flowchart in executing a service in a local site based on the service scenario;

FIG. 4 is a view showing a table of examples of contexts adopted in selecting devices to be used when providing a service and examples of used device selection conditions based on the contexts;

FIG. 5 is a view showing a configuration of software in a broker server, the software dynamically linking devices necessary for the service in providing the service;

FIG. 6 is a view showing a correspondence table between devices to be used, which is created in providing the service;

FIG. 7 is a view showing a system configuration in the case of providing a video streaming distribution service;

FIG. 8 is a view showing an overview of the service scenario in the case of providing the video streaming distribution service;

FIG. 9 is a view showing an information table which is stored in a device management database and managed by the broker server;

FIG. 10 is a view showing a concrete usage of the correspondence table between devices to be used which are necessary in providing a service in the case of providing the video streaming distribution service;

FIG. 11 is a view showing details of a message distributed to each device from the broker server based on the correspondence table between devices to be used in providing a service;

FIG. 12 is a view showing a configuration of middleware which dynamically links devices necessary for a service in providing the service;

FIG. 13 is a flowchart in determining a destination of output data from an application in the middleware which dynamically links the devices necessary for a service in providing the service;

FIG. 14 is a view showing a way of managing devices and functions when a plurality of users simultaneously receive services at the same site in providing the services;

FIG. 15 is a flowchart in selecting devices necessary for a service in providing the service;

FIG. 16 is a flowchart in creating a correspondence table between devices to be used in providing the service;

FIG. 17 is a view showing another system configuration in the case of providing the video streaming distribution service;

FIG. 18 is a chart showing process flows between devices in creating the correspondence table between devices to be used in the middleware based on the service scenario in the case of providing the video streaming distribution service;

FIG. 19 is a view showing an overview of the service scenario in the case of providing a video monitoring service;

FIG. 20 is a view showing a procedure of linking devices for each user in the case where a plurality of users receive the video streaming distribution service and the video monitoring service, respectively, at the same time; and

FIG. 21 is a view showing correspondence tables between devices to be used for different users, which are created in the case of providing the video streaming distribution service and the video monitoring service to the respective users.

### DETAILED DESCRIPTION OF THE INVENTION

At least the following matters will be made clear by the explanation in the present specification and the description of the accompanying drawings.

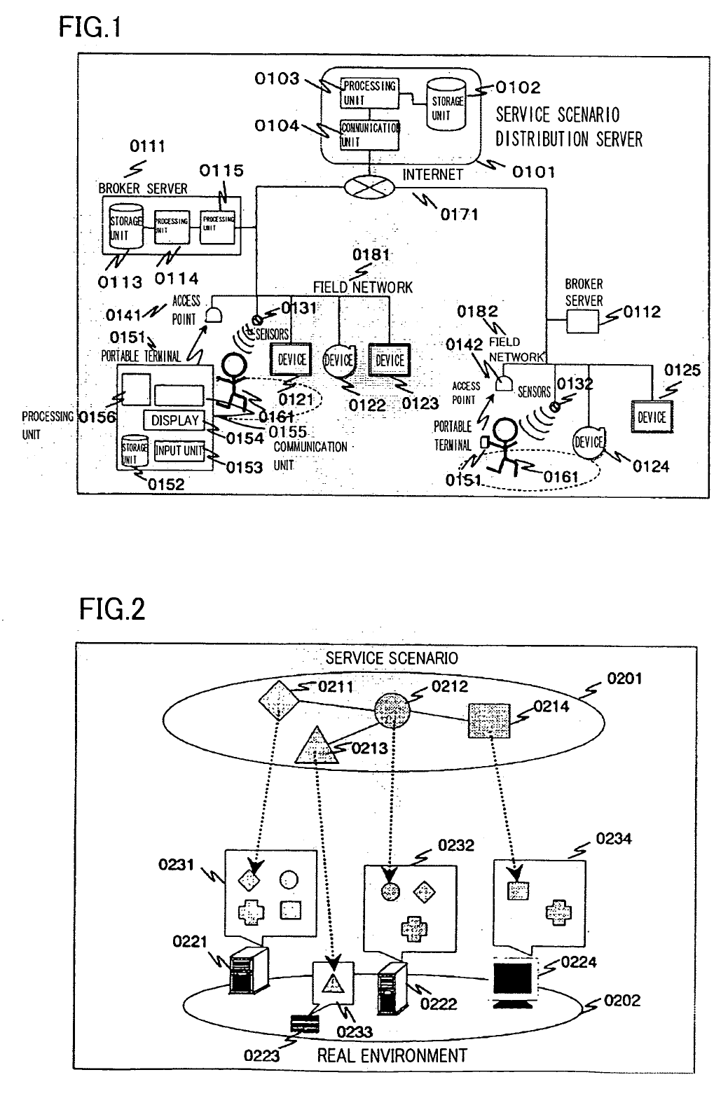

Hereinafter, the preferred embodiment of the present invention will be described in detail below with reference to the drawings. FIG. 1 is a view schematically showing a system to which a service according to the present invention is applied. Main components of the system are a user 0161, broker servers 0111 and 0112, devices 0121, 0122, 0123, 0124, and 0125, sensors 0131 and 0132, access points 0141 and 0142, a service scenario distribution server 0101, and the like. The user 0161 moves with a portable terminal 0151 which can perform wireless communication. The broker servers 0111 and 0112 are placed in each site within an environment. The devices 0121, 0122, 0123, 0124, and 0125, the sensors 0131 and 0132, and the access points 0141 and 0142 are coupled to the broker servers 0111 and 0112 through field networks 0181 and 0182. The service scenario distribution server 0101 is coupled to the broker servers 0111 and 0112 through the Internet 0171. Herein, the field networks 0181 and 0182 are wired or wireless networks.

A hardware configuration of the portable terminal 0151 held by the user 0161 includes a storage unit 0152, an input unit 0153, a display 0154, a communication unit 0155, and a processing unit 0156. The storage unit 0152 stores personal information of the user 0161, information such as a service scenario downloaded from the service scenario distribution server 0101, and software to manage the stored information. The stored information and software are processed by the processing unit 0156. The input unit 0153 is used when the user 0161 enters selection during service execution. On the display 0154, options for the user 0161 during the service execution and the like are displayed. The communication unit 0155 is used for communicating by wireless with the service scenario distribution server 0101 and the broker servers 0111 and 0112 via the access points 0141 and 0142.

A hardware configuration of the broker servers 0111 and 0112 includes a storage unit 0113, a processing unit 0114, and a communication unit 0115. The storage unit 0113 stores the service scenario distributed from the service scenario distribution server 0101; information concerning device attributes; software for communicating with devices to read the service scenario and execute the service; software for managing the devices 0121, 0122, 0123, the sensors 0131, and the like and for detecting an event; and the like. These stored information and software are processed by the processing unit 0114. The communication unit 0115 is used for communicating with the devices 0121, 0122, 0123, the sensors 0131, and the access point 0141, which are coupled through the field network 0181, and for communicating with the service scenario distribution server 0101, which is coupled through the Internet 0171.

A hardware configuration of the service scenario distribution server 0101 includes a storage unit 0102, a processing unit 0103, and a communication unit 0104. The storage unit 0102 stores the service scenario, software for creating and managing the service scenario, software for accepting a request from the user or the broker servers and for distributing the service scenario, and the like. The stored service scenario, software and the like are processed by the processing unit 0103. The communication unit 0104 is used for communicating with the broker servers 0111 and 0112 and the user terminal 0151, which are coupled through the Internet 0171.

The sensors 0131 and 0132 are used for knowing the user's situation. The access points 0141 and 0142 are for allowing the portable terminal 0151 held by the user 0161 to access the networks, and used in communication between the user terminal and the broker servers 0111 and 0112, and between the user terminal and the service scenario distribution server 0101.

FIG. 2 is a view showing an overview of the service scenario describing functions necessary for the service according to the present invention and relations of the functions. The reference numeral 0201 denotes the service scenario. Elements described in the service scenario are applied to devices and the like located within a real environment 0202, thereby executing the service.

In the service scenario 0201, functions 0211, 0212, 0213, and 0214 necessary to execute the service and the relations therebetween are described in general description. Herein, there are interfaces between functions which are linked to each other, such as the functions 0211 and 0212, and the functions 0212 and 0214, and data is exchanged therebetween. In some cases, a device or a piece of software has a plurality of functions as devices 0221, 0222, 0223, and 0224 located in the real environment 0202 have a plurality of functions represented by the reference numerals 0231, 0232, 0233, and 0234, respectively. In executing the service, the devices, software and the like having functions 0211, 0212, 0213, and 0214 are extracted from the environment around the user and linked to each other, thus executing the service.

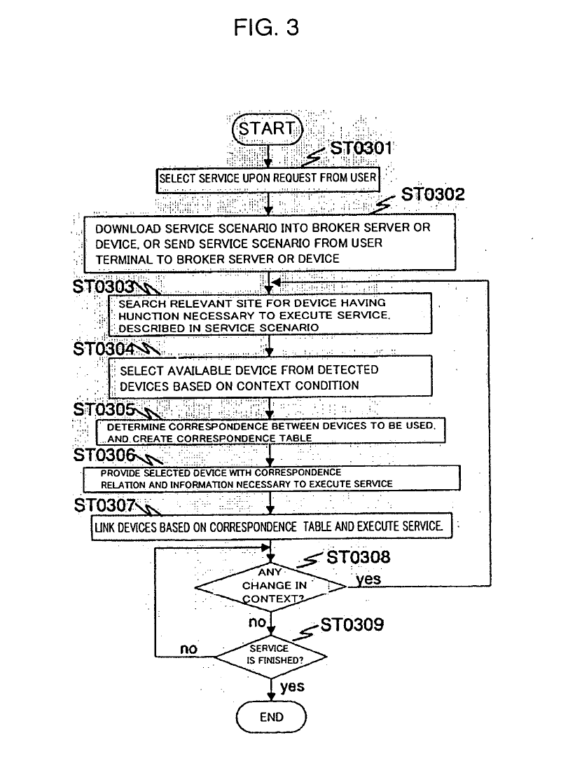

FIG. 3 is a flowchart in executing the service at a local site based on the service scenario according to the present invention. In ST0301, upon accepting a request from a user, the service to be executed is selected. In ST0302, the service scenario is downloaded from the service scenario distribution server to the broker server located near the position of the user. Alternatively, the service scenario saved in the user's terminal is sent to the broker server. In ST0303, the vicinity of the position of the user is searched for devices having functions necessary to execute the service, which are described in the service scenario. In ST0304, available devices are selected from the devices that are detected based on context conditions. In ST0305, correspondence between the selected devices to be used is determined based on the linkage between the functions described in the service scenario, the local device configuration, and the like, to create a correspondence table. Note that when the contexts change, the correspondence table is also immediately updated. In ST0306, the devices selected to execute the service are provided with the correspondence relations between the devices, information necessary to execute the service, and the like. In ST0307, the devices are linked to each other based on the correspondence table created in ST0305, thus executing the service. In ST0308, when the contexts change during service execution, it is required to reconfigure the devices to be used for the service and the device linkages according to the new contexts, and the procedure returns to the process of ST0303. In ST0309, when the service is finished, the exclusive rights of the functions and the devices which have been used are released to end the device linkages.

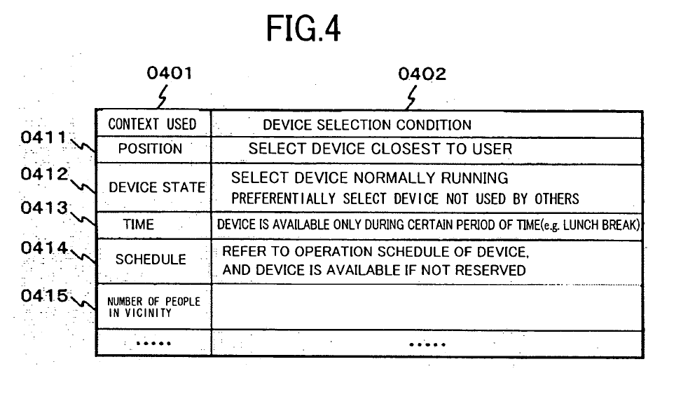

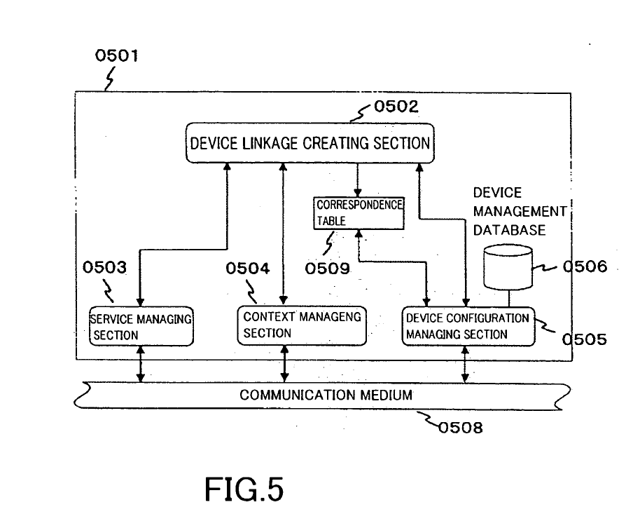

FIG. 4 is a table describing examples of the contexts adopted in selecting devices to be used when providing the service according to the present invention and examples of used device selection conditions based on the contexts. The columns in the table indicate contexts 0401 and used device selection conditions 0402 based on the contexts.

Context information collected as the conditions for selecting the devices to be used includes various information such as a position of a user, states of devices, a state of a surrounding physical environment, a schedule, a time, and the number of people in the vicinity. The usage of the context information can be set according to a service and a situation. Herein, the table lists a location 0411, a device state 0412, a time 0413, a schedule 0414, and the number of people 0415 in the vicinity as typical examples of the contexts 0401, and lists examples of the used device selection conditions 0402 when the context information is used as criteria.

These contexts can be used not only on their own, but also in combination. The conditions of these contexts can be changed and set according to a service, installation locations of devices, types of the devices, attributes of a user, and the like. These conditions are held by a server or middleware arranged in each site and referred to in order to link the devices according to the situation of the user during the service execution.

FIG. 5 is a view showing a configuration of software in the broker server which dynamically links devices necessary for the service in providing the service according to the present invention. The broker server 0501 is placed in each site within the environment and manages devices located in the site. The main components of the broker sever are a device linkage creating section 0502, a service managing section 0503, a context managing section 0504, and a device configuration managing section 0505. The device linkage creating section 0502 creates a correspondence table 0509 of device linkages for providing the service. The service managing section 0503 manages the service scenario and execution of the service. The context managing section 0504 manages contexts in the site. The device configuration managing section 0505 manages a device management database 0506 concerning the devices located in the site, and sends messages concerning a procedure of linking the devices to the respective devices in providing the service.

The service managing section 0503 receives the service scenario through a communication medium 0508. The context managing section 0504 acquires information from the sensors installed within the environment through the communication medium 0508, and always monitors change in the contexts in the site. The device configuration managing section 0505 acquires information from the devices located in the site through the communication medium 0508, and manages the device management database 0506 to monitor the situations of the devices.

The device linkage creating section 0502 creates the correspondence table 0509 between devices to be used for providing the service from the device information received from the device configuration managing section 0505 according to the context information received from the context managing section 0504 based on the service scenario received from the service managing section 0503. Based on the created correspondence table 0509, the device configuration managing section 0505 issues messages concerning the device linkages and operations to the respective devices to be used through the communication medium 0508. The context managing section 0504 always monitors the contexts. If there is a change in the contexts, the correspondence table 0509 is rewritten in the device linkage creating section 0502, and then new messages are issued from the device configuration managing section 0505 to the respective devices, thus implementing dynamic change in the device linkages according to the change in the contexts.

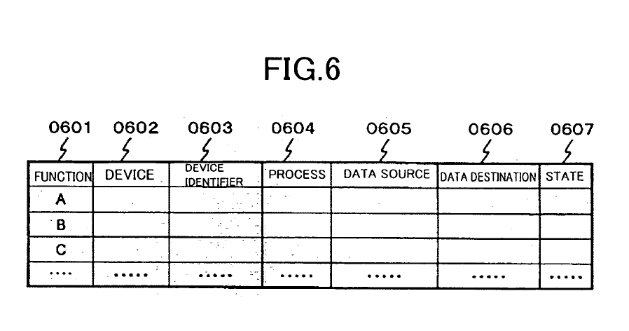

FIG. 6 is a view showing the correspondence table between devices to be used, which is created in providing the service according to the present invention. The main components of the correspondence table are a name of a function 0601 necessary to execute the service, which is described in the service scenario; a name of a device 0602, in the vicinity of the user, having the relevant function necessary to provide the service; an identifier 0603, such as a network address, a name, or an object reference, for uniquely specifying the device having the relevant function necessary to provide the service in the local site; a process 0604 in which the relevant functions necessary to provide the service are running in the device or software; a data source 0605, which is an identifier of the device or the process which sends data to the relevant process; and a data destination 0606, which is an identifier of the device or the process to which the relevant process sends data. In addition, the main components also include a state 0607 such as an operating situation of each device.

In executing the service, a correspondence table between devices to be used is created for each user and separately managed. Accordingly, even when some devices and software are shared by a plurality of users in the case where the same service is provided for the plurality of users in the same site, progress management and device management in providing the service are independently performed for each user, and therefore do not interfere with each other.

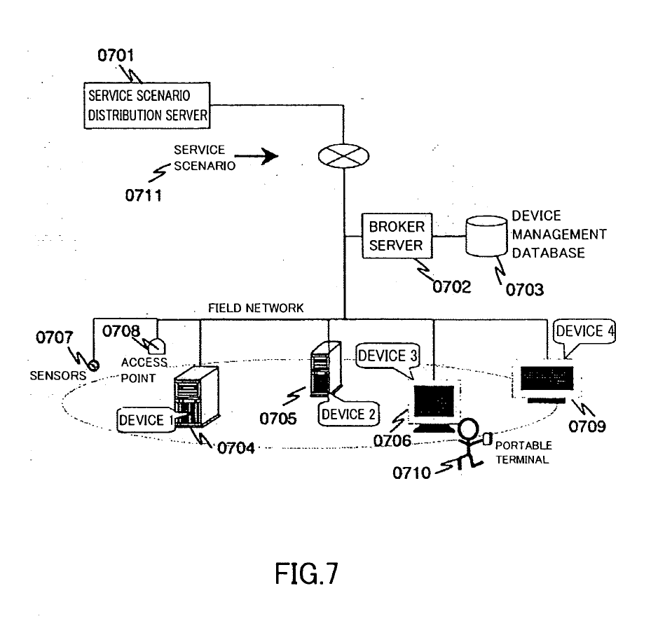

FIG. 7 is a view showing a system configuration in the case of providing a video streaming distribution service as a concrete service application of the service system according to the present invention. Together with FIGS. 8 and 9, FIG. 7 shows a procedure of creating, in a broker server, a correspondence table between devices to be used which are necessary to provide the service by inquiring, with respect to the service scenario, a local server managing device information.

The main components of the system are a service scenario distribution server 0701, a broker server 0702 placed in a site where a user 0710 is, sensors 0707 placed in the site where the user 0710 is and coupled to the broker server 0702 through a field network, and an access point 0708. The service scenario distribution server 0701 distributes the service scenario for providing the service. The sensor 0707 is for knowing the situations of a device 1 (0704), a device 2 (0705), a device 3 (0706), and a device 4 (0709), as well as the situation in the environment. The access point 0708 is for allowing the user 0710 to communicate with the service scenario distribution server 0701 and the broker server 0702. The broker server 0702 manages a device management database 0703 storing information concerning the devices located in the site. When there is a request for a service from the user, the broker server 0702 receives a service scenario 0711 from the service scenario distribution server 0701.

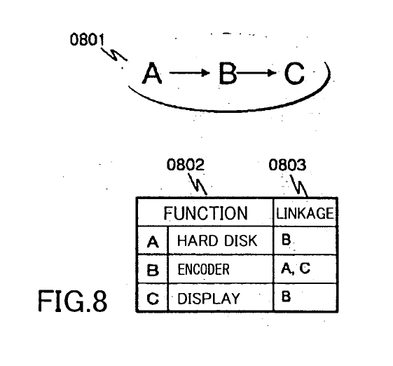

FIG. 8 is a view showing an overview of the service scenario in the case of providing the video streaming distribution service as the concrete service application of the service system according to the present invention. There are three functions 0802 necessary for the video streaming distribution service, which are a function A: hard disk to save video contents, a function B: encoder to perform a streaming distribution, and a function C: display to output video. As for linkages 0803, the function A is linked to the function B, the function B is linked to the functions A and C, and the function C is linked to the function B. Accordingly, the functions A, B, and C are related to each other as shown by the reference numeral 0801.

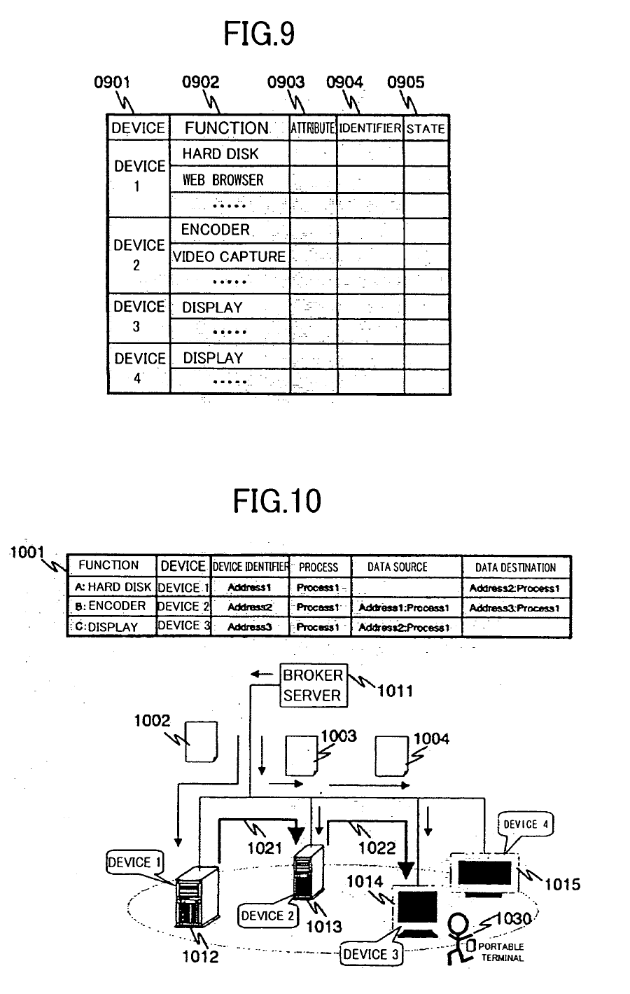

FIG. 9 is a table showing information stored in the device management database, which is managed by the broker server according to the present invention. The main components of the information are a name of a device 0901 which is located in the site managed by the broker server, a name of a function 0902 which the relevant device has, an attribute 0903 such as a specification of the device and an interface of the function, an identifier 0904 for specifying the relevant function and device on the network, and a state 0905, showing an operating situation of the device. Herein, the device 0901 includes not only one function 0902, but in some cases, includes a plurality of functions 0902. The attribute 0903, the identifier 0904, the state 0905 can be described for each function. These pieces of information are updated when the broker server regularly, acquires information on each device or when, each device regularly reports the state thereof to the broker server.

The service scenario distribution server 0701 sends the service scenario 0711 for the video streaming distribution service to the broker server 0702 upon request for the service from the user 0710. In the broker server 0702, devices having the functions necessary to provide the service are selected by referring to the functions 802 described in the service scenario 0711 and to the device information (FIG. 9) stored in the device management database 0703. Herein, selected are the device 1 (0704) as a device having the function A: hard disk, the device 2 (0705) as a device having the function B: display, and the device 3 (0706) as a device having the function C: display. There are two devices here, the devices 3 (0705) and 4 (0706), as the device having the function C: display. However, when the position of the user 0710 is used as a criterion among the context conditions, the device 3 (0706), which is closer to the user 0710, is selected as the device providing the display.

After the devices to be used in executing the service are selected, the identifiers of the devices having the functions linked to the functions 0802 described in the service scenario are extracted from identifiers 0904 stored in the device management database 0703, and stored in the fields of the data source 0605 and the data destination 0606 in the correspondence table between devices to be used shown in FIG. 6. The devices are linked to each other based on the thus created correspondence table between devices to be used, thereby providing the service.

FIG. 10 is a view showing a concrete usage of the correspondence table between devices to be used which are necessary in providing the service according to the present invention in the case of providing the video streaming distribution service as the service application. Herein, the video streaming distribution service is the same as the service taken in FIGS. 7 to 9, and the correspondence table between devices to be used is one which is created according to the procedure described in FIGS. 7 to 9.

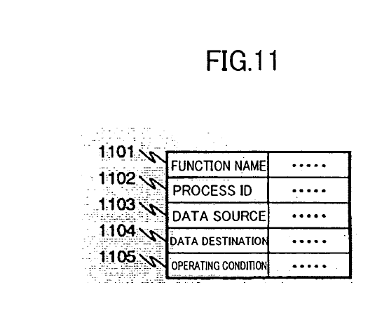

When a correspondence table 1001 between devices to be used is created in a broker server 1011, messages 1002, 1003 and 1004 concerning the device linkages and operations are sent from the broker server 1011 to devices 1012, 1013 and 1014, respectively, which are described in the correspondence table 1001. Each of these messages includes items concerning each device which are extracted from the correspondence table 1011 (shown in FIG. 11 in detail) and operating conditions in executing the service. Each of the devices 1012, 1013 and 1014 performs operations and linkage with each other to provide the service based on these messages 1002, 1003 and 1004, respectively.

According to the correspondence table 1001 between devices to be used which is created for the video streaming distribution service, the identifier of the data destination of Process 1 of the device 1 (1012) is “Address 2: Process 1,” and therefore the device 1 (1012) sends data to the device 2 (1013) (1021). The data source of Process 1 of the device 2 (1013) is “Address 1: Process 1,” and the data destination thereof is “Address 3: Process 1,” and therefore the device 2 (1013) receives the data from the device 1 (1012) as described above (1021) and sends the data to the device 3 (1014) (1022). In the device 3 (1014), the data source of Process 1 is “Address 2: Process 1,” and therefore the device 3 (1014) receives the data from the device 2 (1013) as described above (1022). The field of the data destination thereof is blank, and therefore the device 3 (1014) sends no data to another device.

By the linkages between the devices as described above, video data stored in the hard disk of the device 1 (1012) is encoded in the device 2 (1013) and outputted at the device 3 (1014), thus implementing the video streaming distribution service.

Note that if the contexts change during the service execution, the devices to be used are dynamically changed. For example, when a user 1030 moves during the service execution from near the device 3 (1014) in service to near the device 4 (1015), or when the device 3 (1014) fails, the correspondence table 1001 is updated, and the use of the device 3 (1014) is stopped. In place of the device 3 (1014), the device 4 (1015) begins to be used, and the data destination of the device 2 (1013) is changed from the device 3 (1014) to the device 4 (1015).

FIG. 11 is a view showing details of the message distributed from the broker server to each device based on the correspondence table between devices to be used in providing the service according to the present invention. The main components of the message are a function name 1101 to be used, a process ID 1102 of a process where the relevant function is running, a data source 1103 which is an identifier of a function which sends data to be received by the relevant function, a data destination 1104 which is an identifier of a function to which the relevant function sends data, and an operating condition 1105 concerning start-up or behavior of each function or device. This message is sent from the broker server when any change occurs in the device configuration.

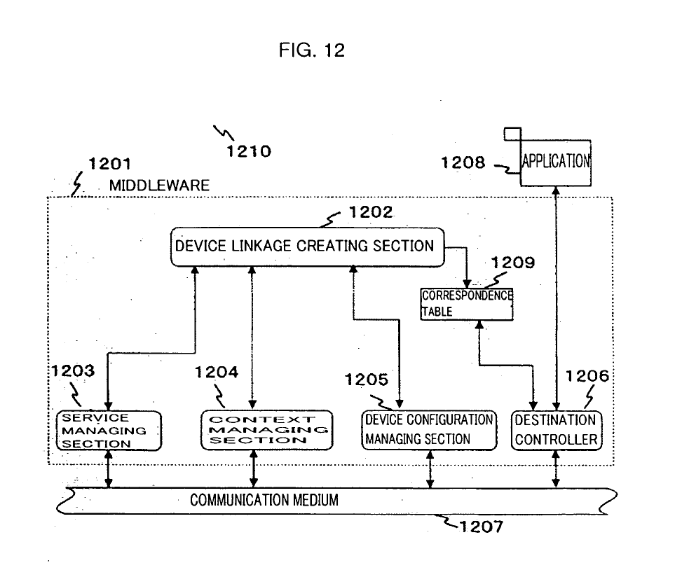

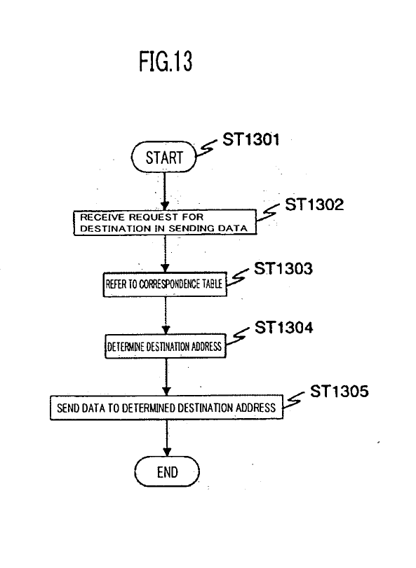

FIG. 12 shows a configuration of middleware for dynamically linking devices necessary for the service in providing the service according to the present invention. In a device 1210 within the environment, together with an application 1208 for providing the service, middleware 1201 is present to link devices. The main components of the middleware 1201 are a device linkage creating section 1202, a service managing section 1203, a context managing section 1204, a device state managing section 1205, and a destination controller 1206. The device linkage creating section 1202 creates a correspondence table 1209 of linkages between devices to be used for providing the service. The service managing section 1203 manages the service scenario and the execution of the service. The context managing section 1204 manages contexts in the site. The device state managing section 1205 manages the states of the devices. The destination controller 1206 determines a destination of output data from the application 1208 according to the device linkages and the contexts. Herein, this correspondence table 1209 of device linkages is that shown in FIG. 6. When this middleware is applied to a system with the system configuration shown in FIG. 7 excluding the broker server 0702 and the device management database 0703 in the case of providing the video streaming distribution service as a concrete application example similarly to FIGS. 7 to 11, the service application as shown in FIG. 10 can be applied in the same manner as described earlier.

The service managing section 1203 receives a service scenario through a communication medium 1207. The context managing section 1204 acquires information from sensors installed within the environment through the communication medium 1207 and thereby always monitors changes in the contexts in the site. The device state managing section 1205 manages operating situations, usage situations, and the like of the devices.

The device linkage creating section 1202 creates the correspondence table 1209 of device linkage for providing the service from the device information received from the device configuration managing section 1205 according to the context information received from the context managing section 1204 based on the service scenario received from the service managing section 1203. The context managing section 1204 always manages changes in the contexts and has the device linkage creating section 1202 rewrite the correspondence table 1209 of device linkages every time a change occurs.

Whenever the application 1208 outputs data, the destination controller 1206 assigns a destination to the data with reference to the correspondence table 1209 of device linkages and then sends the data, thus implementing dynamic device linkages according to changes in the contexts. Herein, the middleware performs a process of sending output data from the application, but in some cases, the destination, which has been assigned by the destination controller 1206 referring to the correspondence table, of the output data from the application is returned to the application, and the application performs the sending process.

FIG. 13 is a flowchart in determining a destination of output data from the application in the middleware which dynamically links devices necessary for the service in providing the service according to the present invention. When data is outputted by the application, which is included in each device and realizes the function necessary to provide the service, the data is always once sent to the destination controller 1206 shown in the middleware configuration of FIG. 12. After the destination is assigned to the output data according to the contexts, the data is sent to the assigned destination. Therefore, it is unnecessary to consider the destination of the output data when designing the application, and man-hours and the burden on the development can be reduced.

In ST1301, the destination controller 1206 accepts a request for a data destination from the application. In ST1302, the destination controller 1206 refers to the correspondence table 1209 of device linkages. In ST1303, a destination address of output data from the application is determined based on the correspondence table 1209. In ST1304, the destination controller 1206 sends the output data from the application to the destination address determined in the previous step, ST1303.

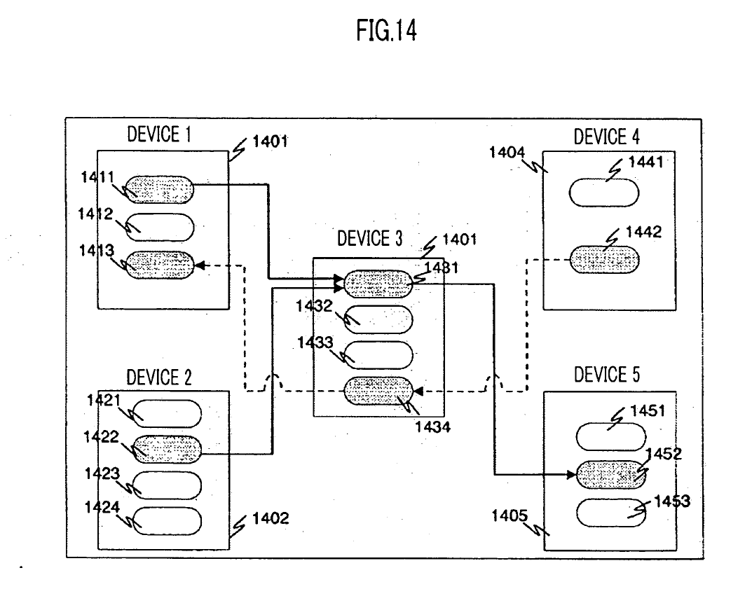

FIG. 14 is a view showing a way of managing devices and functions when a plurality of users simultaneously receive the services in the same site in providing the services according to the present invention. There are five devices 1401, 1402, 1403, 1404, and 1405, each having a plurality of functions (1411 to 1413, 1421 to 1424, 1431 to 1434, 1441 and 1442, 1451 to 1453, respectively). The services are simultaneously provided to two users. One user is provided with the service by the combination of the functions 1411, 1422, 1431, and 1452, and the other user is provided with the service by the combination of 1413, 1434, and 1442. Herein, the device 3 (1401) is shared by the two users. However, the service execution is managed by the correspondence tables of device linkages prepared for the respective users. Accordingly, even when the service for one user is finished, it does not occur that the right for operating the shared device 3 (1401) is released, and the service being provided for the other user is stopped.

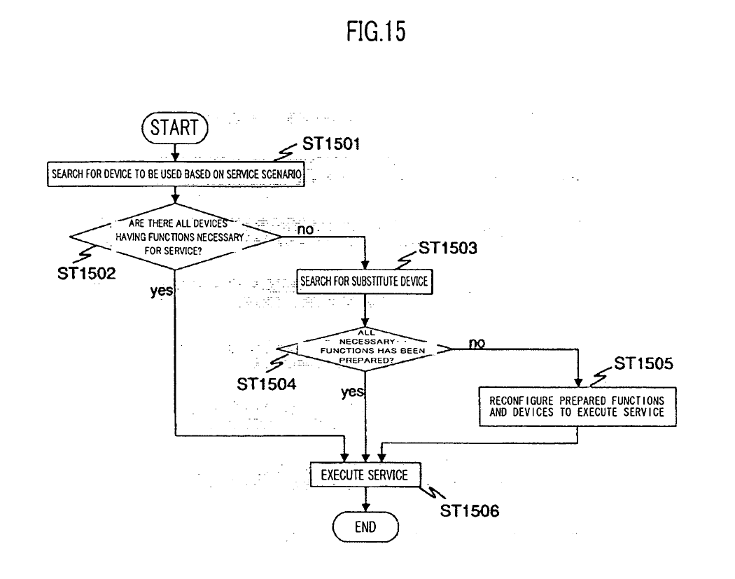

FIG. 15 is a flowchart in selecting devices necessary for the service in providing the service according to the present invention. In ST1501, a local site is searched for devices having functions necessary for the service based on the service scenario. In ST1502, when all the devices having the functions necessary for the service are detected as a result of the search and the detected devices are available, the service is executed in ST1506. On the contrary, in the ST1502, when not all the devices having the functions necessary for the service are detected, the site is searched for substitute devices in ST1503. In ST1504, when all the devices having the necessary functions are prepared by adding the substitute devices that are detected, the service is executed in ST1506. Note that the service provided here is one at the same level as that described in the service scenario. When not all the devices having the necessary functions are prepared even by adding the detected substitute devices in ST1504, the configuration is restructured so as to execute the service with only the prepared functions and devices, thus executing the, service in ST1506. Herein, the level of the service is restricted depending on the prepared devices.

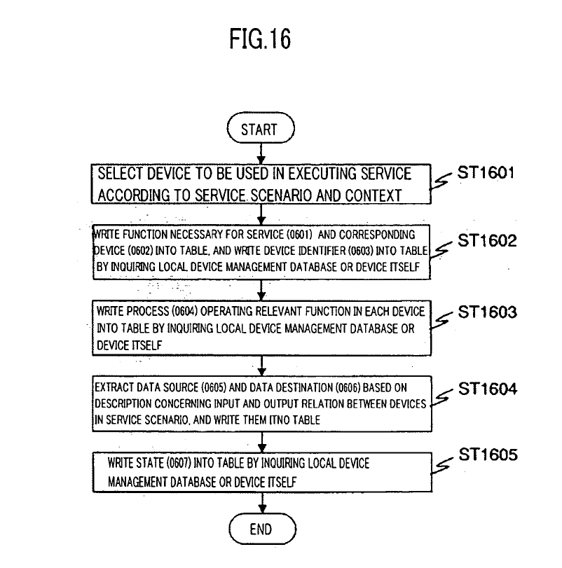

FIG. 16 is a flowchart for creating the correspondence table between devices to be used in providing the service according to the present invention. The correspondence table between devices to be used, which is created here, is that shown in FIG. 6. The reference numerals 0601 to 0607 in the description below correspond to the reference numerals 0601 to 0607 shown in FIG. 6, respectively.

In ST1601, devices to be used in executing the service are selected according to the service scenario and the contexts. In ST1602, among the selected devices, the devices (0602) corresponding to the functions (0601) necessary for the service and the device identifiers of the respective devices, which are acquired by inquiring the local device management database or the devices themselves, are associated with each other and written in the table. In ST1603, the identifiers (0604) of processes operating the relevant functions are written in the table by inquiring the local device management database or the devices themselves. In ST1604, the data source (0605) and the data destination (0606) for each device are extracted based on the description concerning the input and output relations between devices in the service scenario and written in the table. In ST1605, the operating states (0607) of the devices and the functions are written in the table by inquiring the local device management database or the devices themselves.

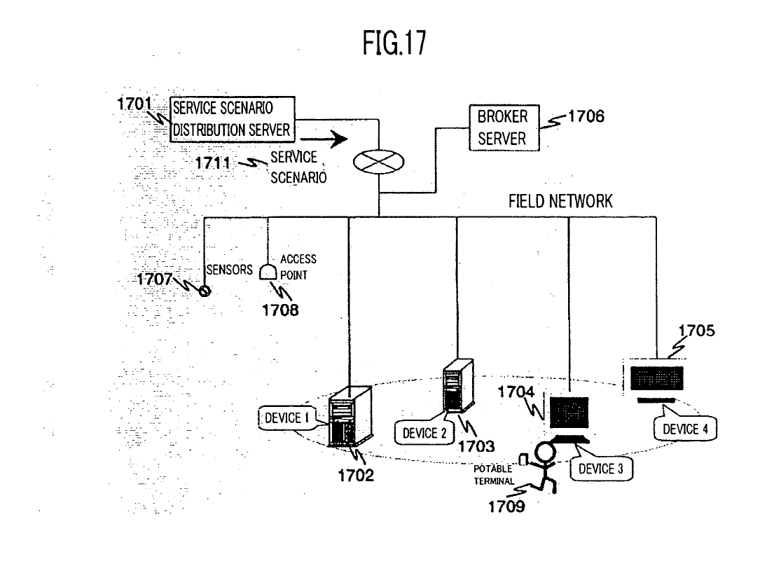

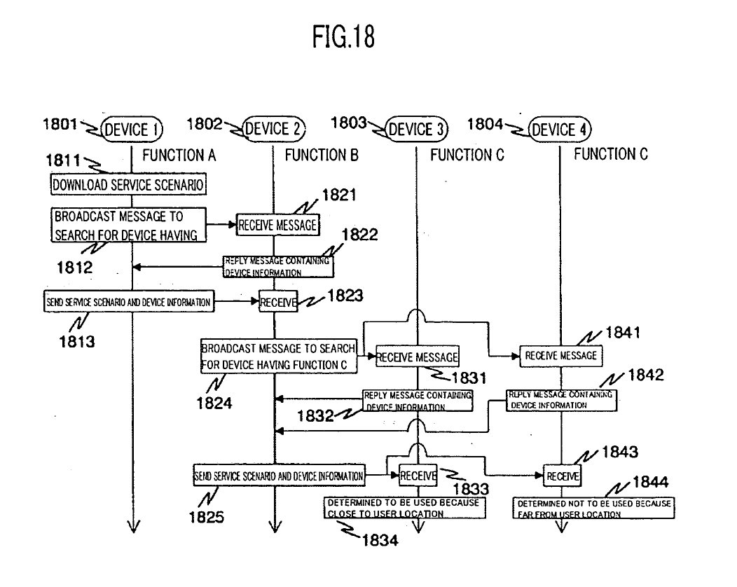

FIG. 17 is a view showing a system configuration in the case of providing the video streaming distribution service as a concrete service application of the service system according to the present invention. Hereinafter, together with FIG. 18, FIG. 17 shows a procedure of creating, in the middleware, a correspondence table between devices to be used which are necessary to provide the service by searching the devices themselves for the devices to be used based on the service scenario without the provision of a device management database holding information concerning local devices.

The main components of the system are a service scenario distribution server 1701, a broker server 1706 placed in a site where a user 1709 is, sensors 1707 placed in the site where the user 1709 is and coupled to the broker server 1706 through a field network, and an access point 1708. The service scenario distribution server 1701 distributes the service scenario for providing the service. The sensors 1707 are for knowing the situations of a device 1 (1702), a device 2 (1703), a device 3 (1704), and a device 4 (1705), as well as the situation in the environment. The access point 1708 is for allowing the user 1709 to communicate with the service scenario distribution server 1701 and the broker server 1706. The service scenario 1711 is a service scenario for the video streaming distribution service shown in FIG. 8.

The service scenario 1711 for the video streaming distribution service is sent from the service scenario distribution server 1701 upon request for the service from the user 1709. The sent service scenario 1711 is first downloaded in any one of the devices having the functions described in the service scenario in the site where the user 1709 is. Thereafter, the devices necessary to execute the service are selected based on the service scenario 1711 by exchange of information between the devices, and the correspondence table between the devices is created.

FIG. 18 is a chart showing a process flow between devices in creating, in middleware, the correspondence table between devices to be used based on the service scenario in the case of providing the video streaming distribution service as a concrete service application of the service system according to the present invention. Devices 1 to 4 (1801 to 1804) correspond to the devices 1 to 4 (1702 to 1703) in FIG. 17, respectively. The device 1 (1801) has the function A: hard disk, the device 2 (1802) has the function B: encoder, and each of the devices 3 and 4 (1804 and 1805) has the function C: display, the functions A, B and C being described in the service scenario shown in FIG. 8.

First, the service scenario is downloaded from the service scenario distribution server in the device 1 (1801) (1811). According to the functions 0802 and the linkages 0803 described in the service scenario of FIG. 8, the function A: hard disk is linked to the function B: encoder. Therefore, a message to search for a device having the function B (encoder) is broadcasted from the device 1 (1801) on the field network (1812). The device 2 (1802) having the function B: encoder receives the above message (1821). The device 2 (1802), in response to the above received message, replies a message containing the device information such as its own identifier to the device 1 (1801) (1822). Upon receiving the reply message from the device 2 (1802), the device 1 (1801) sends the service scenario and the device information of the device 1 (1801) to the device 2 (1802) (1813). When the device 2 (1802) receives the above information (1823), it becomes possible that the device 1 (1801) and the device 2 (1802) exchange data, and a linkage between the function A: hard disk and the function B: encoder, which are described in the service scenario, can be established.

Subsequently, the device 2 (1802), in accordance with the description of the service scenario (FIG. 8) received from the device 1 (1801), broadcasts a message to search for a device having the function C: display, which is linked to the function B and has not been detected yet, on the field network (1824). The devices 3 and 4 (1803 and 1804), each having the function C: display, receive the message (1831 and 1841). The devices 3 and 4 (1803 and 1804), in response to the above message, reply messages containing the device information such as their own identifiers to the device 2 (1802) (1832 and 1842). Upon receiving the reply messages from the devices 3 and 4 (1803 and 1804), the device 2 (1802) sends the service scenario and the device information of the device 2 (1802) to each of the devices 3 and 4 (1803 and 1804) (1825).

This enables data exchange between the devices 2 and 3 (1802 and 1803), and between devices 2 and 4 (1802 and 1804). Thus, linkages can be established between the function B: encoder and the function C: display, which is described in the service scenario (FIG. 8). Herein, although two devices having the function C are selected, the device 3 (1803), which is located at a position closer to the user 1709, is determined to be used according to “position,” a condition of the contexts (1834). The use of the device 4 (1804) is relinquished (1844). The device to be used may be selected according to the contexts such as the usage situation of each device other than the position of the user 1709.

During the process of selecting the devices having the functions 0802 described in the service scenario (FIG. 8), the relations of exchanging information between the devices to be used are also established based on the linkages between the functions 0802. Accordingly, pieces of the information are stored in the fields of the data source 0605 and of the data destination 0606, which are the items of the correspondence table between devices to be used shown in FIG. 6, along the process flow shown in FIG. 18, and thus the correspondence table is created in parallel. The devices are linked to each other based on the thus created correspondence table of devices to be used, thereby providing the service.

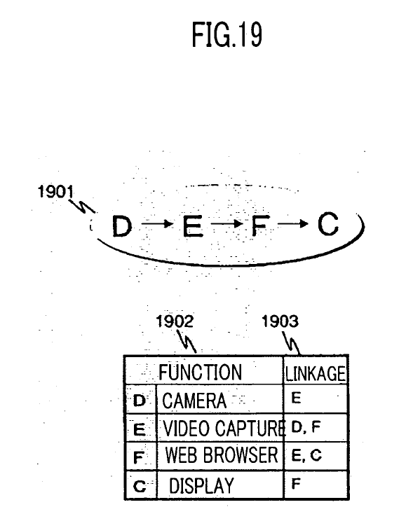

FIG. 19 is a view showing an overview of a service scenario in the case of providing a video monitoring service as a concrete service application of the service system according to the present invention. There are four functions 1902 necessary for the video monitoring service, which are a function D: camera to input images therein, a function E: video capture to capture the images from the camera, a function F: Web browser to display the images, and a function C: display to output the displayed images to a user. As for linkages 1903, the function D is linked to the function E, the function E is linked to the functions D and F, the function F is linked to the functions E and C, and the function C is linked to the function F, and these functions are related to each other as shown by the reference numeral 1901.

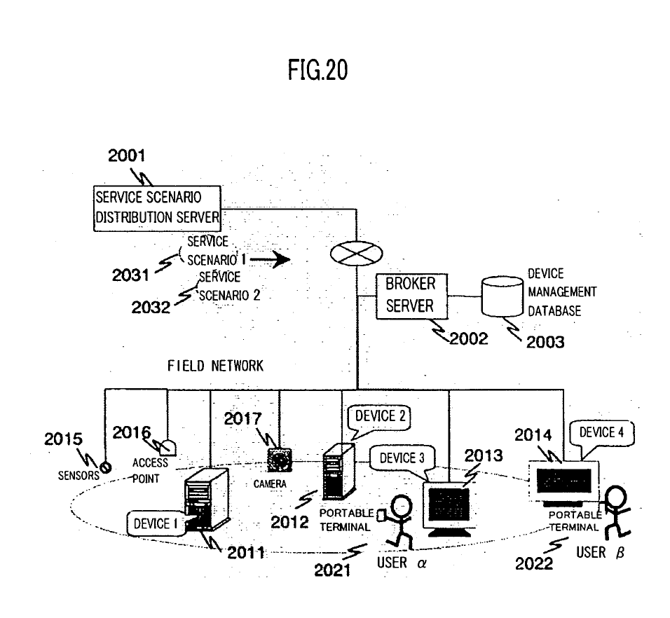

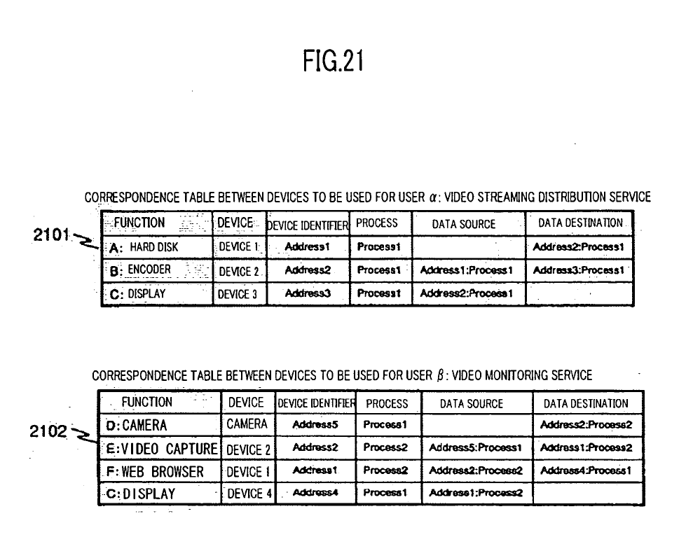

FIG. 20 is a view showing a procedure of linking devices for each user in the case where a plurality of users simultaneously receive the video streaming distribution service and the video monitoring service, respectively, as concrete service applications, in the service system according to the present invention. Herein, as for service scenarios 2031 and 2032, the service scenario for the video streaming distribution service is that shown in FIG. 8, and the service scenario for the video monitoring service is that shown in FIG. 19. FIG. 21 shows correspondence tables between devices to be used, which are created by the procedure shown in FIG. 3 based on the above service scenarios and contexts. These tables are created for users α 2021 and β 2022, respectively, by the procedure shown in the description concerning FIGS. 7 to 9, or FIGS. 17 and 18, and are independently managed.

In order to provide the video streaming distribution service to the user α 2021, a device 1 (2011) having the function A: hard disk, a device 2 (2012) having the function B: encoder, and a device 3 (2013) having the function C: display are used based on the correspondence table 2101 between devices to be used shown in FIG. 21. In order to provide the video monitoring service to the user β 2022, a camera 2017 having the function D: camera, the device 2 (2012) having the function E: video capture, the device 1 (2011) having the function F: Web browser, and a device 4 (2014) having the function C: display are used based on the correspondence table 2102 between devices to be used shown in FIG. 21. Therefore, the devices 1 and 2 (2011 and 2012) are shared.

Note that separate instances are created for the user α 2021 and the user β 2022, and the correspondence tables 2101 and 2102 between devices to be used are separately managed. Accordingly, the services can be provided to the user α 2021 and the user β 2022 using the same devices at the same time, even when the services are different. Moreover, for example, even when the user α 2021 finishes the service first and releases the used devices, the instance for the user β 2022 continues to hold the devices 1 and 2 (2011 and 2012), which have been shared with the user α 2021. Accordingly, the user β 2022 can receive the service regardless of the situation of the user α 2021. In this manner, a plurality of users can receive respective services without interfering with each other even when sharing the devices.

FIG. 21 shows the correspondence tables between devices to be used for different users, which are created in the case of providing the video streaming distribution service and video monitoring service to the respective users as concrete service applications of the service system according to the present invention. The correspondence table 2101 between devices to be used for the user α and the correspondence table 2102 between devices to be used for the user β are created by the procedure shown in the description concerning FIGS. 7 to 9 or FIGS. 17 and 18 in the environment shown in FIG. 20. The correspondence table 2101 is created in the case where the user α 2021 is provided with the video streaming distribution service based on the service scenario shown in FIG. 8, and the correspondence table 2102 is created in the case where the user β 2022 is provided with the video monitoring service based on the service scenario shown in FIG. 19.

According to the present invention, since the service and the devices can be separately managed, it is unnecessary to take into account the devices to be actually used when designing the service. Moreover, it is possible to provide the same services in many sites with no burden without preparing the same pieces of equipment for the services, and it is possible to increase the variations of a service which can be provided in one site.

Although the preferred embodiment of the present invention has been described in detail, it should be understood that various changes, substitutions and alterations can be made therein without departing from spirit and scope of the inventions as defined by the appended claims.

What is claimed is:

1. A distributed system in which a plurality of devices are coupled to each other through a network, comprising:
a service scenario which describes functions necessary to provide a service and relations between the functions in general description;
a context which serves as a criterion for selecting devices to be used in providing the service;
an extraction unit which extracts devices necessary for the service based on the service scenario;
a detection unit which detects devices located in a site where the service can be provided to a service requester; and
a service execution unit which executes the service for the service requester by linking the devices detected based on the context.

2. A distributed system according to claim 1, wherein the extraction unit extracts the devices by inquiring a server holding a database concerning attribute information of the devices.

3. A distributed system according to claim 1, wherein the detection unit detects the devices located in the site where the service can be provided by acquiring information on the devices extracted by the extraction unit.

4. A distributed system according to claim 3, wherein the service execution unit collects information from the devices detected by the detection unit and compares the collected information with context information to select available devices.

5. A distributed system according to claim 1, wherein when the context changes while the service is being executed, the detection unit redetects devices in accordance with the context having changed.

6. A distributed system according to claim 1, wherein, when it is detected, while the service is being executed, that there is a change in situations of the devices located in the site where the service can be provided to the service requester, the detection unit redetects devices.

7. A distributed system according to claim 1, wherein relations between the devices necessary to execute the service are held for each user requesting the service, and the devices are linked depending on the users.

8. A brokering method using a context in a distributed system in which a plurality of devices are coupled to each other through a network, the method comprising the steps of:
preparing a service scenario and a context, the service scenario describing functions necessary to provide a service and relations between the functions in general description, the context serving as a criterion for selecting devices to be used in providing the service;
extracting devices necessary for the service based on the service scenario;
detecting devices located in a site where the service can be provided to a service requester; and
executing the service for the service requester by linking the devices detected based on the context.

9. A brokering method using a context according to claim 8, wherein, in the extracting step, the devices are extracted by inquiring a server holding a database concerning attribute information of the devices.

10. A brokering method using a context according to claim 8, wherein, in the detecting step, the devices located in the site where the service can be provided are detected by acquiring information on the devices extracted in the extracting step.

11. A brokering method using a context according to claim 10, wherein, in the step of executing the service, information is collected from the devices detected in the detecting step, and the collected information is compared with context information to select available devices.

12. A brokering method using a context according to claim 8, wherein when the context changes while the service is being executed, devices are redetected in accordance with the context having changed.

13. A brokering method using a context according to claim 8, wherein when it is detected, while the service is being execute, that there is a change in situations of the devices located in the site where the service can be provided to the service requester, devices are redetected.

14. A brokering method using a context according to claim 8, wherein relations between the devices necessary to execute the service are held for each user requesting the service, and the devices are linked depending on the users.
